(19) United States
(12) Patent Application Publication
(10) Pub. No.: US 2010/0058433 A1
(43) Pub. Date: Mar. 4, 2010

(54) MODULAR DATA SYNCHRONIZATION METHOD

(75) Inventor: Stephan Szabo, San Francisco, CA (US)

Correspondence Address: Trellis Intellectual Property Law Group, PC, 1900 EMBARCADERO ROAD, SUITE 109, PALO ALTO, CA, 94303, US

(73) Assignees: Sony Corporation, Tokyo (JP); Sony Electronics, Inc., Parkridge, NJ (US)

(21) Appl. No.: 12/200,642

(22) Filed: Aug. 28, 2008

(51) Int. Cl. H04L 9/00

(52) U.S. Cl. 726/1

(57) ABSTRACT

In one embodiment, policies and sources may be used to synchronize data. Sources, which contain knowledge about files and metadata, can pass events to policies when changes in data are detected. The policies may then manage the data synchronization with other sources. The sources are agnostic as to how the data is synchronized between sources. Also, the policies are agnostic of the data that is being managed by sources. Accordingly, a modular infrastructure is provided that allows sources and policies to be configured to interact modularly.

### BACKGROUND

Particular embodiments generally relate to data synchronization.

Files can be synchronized between systems. Different applications may have different requirements as to the rules governing how these files are synchronized. Typically, applications need different applications for performing different types of synchronization that have different rules. Developing applications for each synchronization requires creating a new synchronization architecture for each set of rules. An application written directly to use one set of rules on data it knows about is of little use to another application with its own set of rules. Accordingly, data synchronization is not scalable.

### SUMMARY

Particular embodiments generally relate to data synchronization using modular policies and sources.

In one embodiment, policies and sources may be used to synchronize data. Sources, which contain knowledge about files and metadata, can pass events to policies when changes in data are detected. The policies may then manage the data synchronization with other sources. The sources are agnostic as to how the data is synchronized between sources. Also, the policies are agnostic of the data that is being managed by sources. Accordingly, a modular infrastructure is provided that allows sources and policies to be configured to interact modularly. This allows the synchronization architecture to be scalable.

A common interface may be provided that allows sources to communicate events to policies. The policies can then manage the data synchronization based on a set of rules. The policies can determine actions to be performed to synchronize data. Configuration as to how the events are sent and how actions to synchronize the data are not needed due to the common interface. Thus, a device may have a policies and sources instantiated, and have data synchronization performed without customizing communication between them.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system for synchronizing data according to one embodiment.

FIG. 2 depicts an example of sources and policies according to one embodiment.

FIG. 3 depicts a simplified flowchart of a method for configuring a device according to one embodiment.

FIG. 4 depicts a simplified flowchart of a method for performing data synchronization according to one embodiment.

FIG. 5 depicts a more detailed example of devices that can be used for data synchronization according to one embodiment.

### DETAILED DESCRIPTION OF EMBODIMENTS

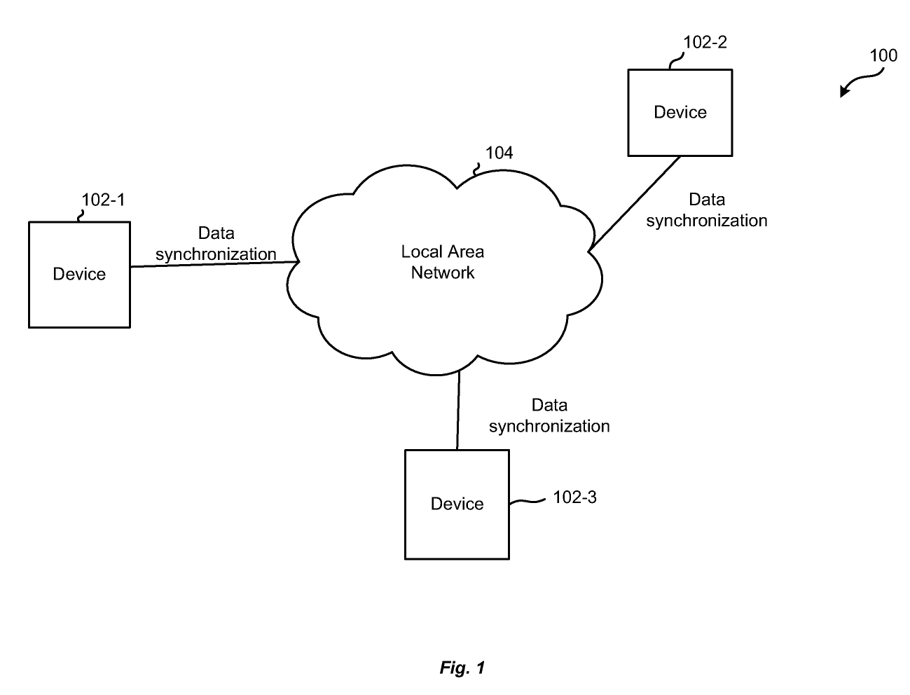

FIG. 1 depicts an example of a system 100 for synchronizing data according to one embodiment. A plurality of devices 102 may communicate through a network 104 to synchronize data.

Devices 102 may be any suitable computing devices that may want to synchronize data. For example, devices 102 include personal computers, laptop computers, cellular phones, set top boxes, televisions, or other computing devices that may need data synchronization. In one example, devices 102 include consumer electronic devices. The consumer electronic devices may be devices made by a specific brand or company. In other embodiments, the consumer electronic devices may be made by different companies or brands.

Network 104 may be a wireless, wired, or any other combination of network. Networks 104 may include a home network or local area network (LAN). For example, a user may have a home network in their home. Also, network 104 may be a wide area network (WAN), such as the Internet.

Devices 102 may synchronize data amongst each other. For example, device 102-1 may synchronize data with device 102-2 and/or device 102-3. Also, device 102 may synchronize data within itself, that is, intra device. For example, an application may synchronize data from a first source to a second source that is found within device 102.

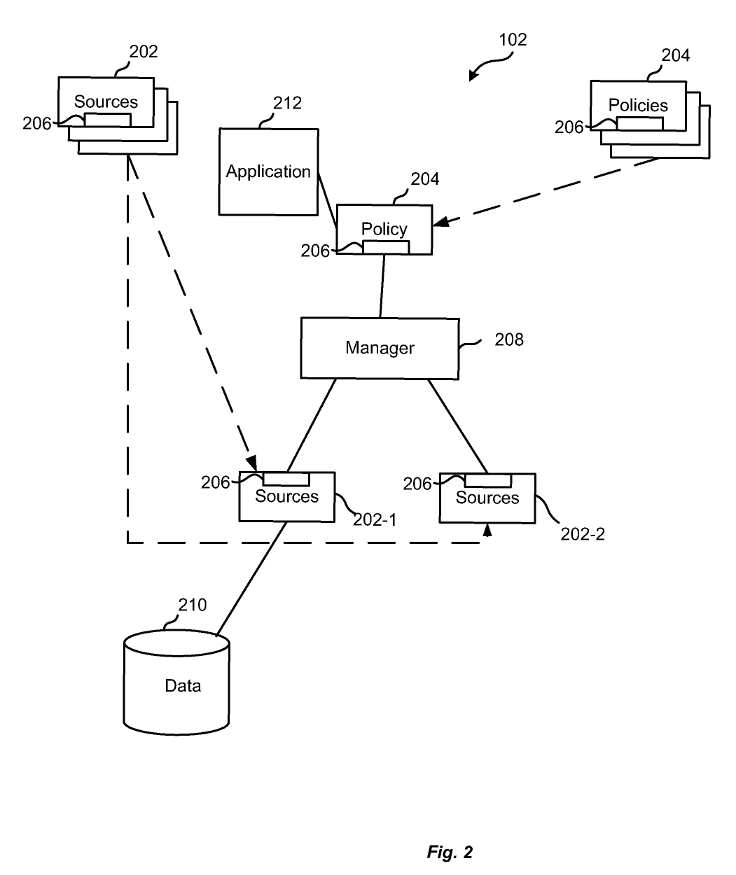

FIG. 2 depicts an example of sources 202 and policies 204 according to one embodiment. Sources 202 contain knowledge about data. For example, a source 202 may be configured to manage files and/or metadata that are stored in storage 208. Sources 202 may be a set of code that reads data from and/or writes data to another source 202, either inside or outside of device 102. One example of a source 202 is one that reads files from a local disk drive and also writes data to another local disk drive. Other sources might read and write to another device 102 over network 104. Sources 202 may perform synchronization actions, such as reading data, writing data, sending data, etc. For example, some sources 202 may only read data, such as a source might read files from an external news feed. Another source 202 might write data to a server that sends the data by e-mail.

Sources 202 may control data. For example, data may include files and/or metadata that may be stored in storage 208. Sources 202 may detect events that occur with the data. For example, changes in the data may be detected and events describing the change can be generated. Events may be sent to source 204 for processing.

Policies 204 may be a set of rules for synchronizing between sources 202. A policy controls how data is synchronized from one source 202 to another source 202. Also, policy 204 may control how data for source 202 is reported to a user interface. Policies 204 receive events from sources 202 and process them based on rules to determine actions to perform. For example, a policy intends to make a number of sources 202 identical by copying data from one source 202 to another source. A source 202-1 may include files or data that are not included on a source 202-2. The policy is configured to make sure that files and/or data included for source 202-1 are synchronized with source 202-2. Thus, when changes for sources 202-1, an action to copy changed data for the files to source 202-2 is generated.

Sources 202 and policies 204 include an interface 206. Interface 206 may be common among sources 202 and policies 204 that can be connected among each other. A common interface means that each interface can be used to send signals that are understood by the other interface 206. For example, the commands used by interfaces 206 are known to each interface 206. In one example, a method to create an item is called by a generic command, such as create( ). When policy 204 wants a source 202 to create an item, the command create( ) may be used. Policy 204 does not need to know how the source implements the create( ) command, but rather that the source will create the item which may write to a storage 208 or send a message over network 104 or do some other action. Because of common interface 206, customizing how to communicate between the interfaces is not needed. Also, knowledge of what data the source is managing is not needed by the policy and knowledge of what policy is being enforced is not needed by the source.

A class of sources 202 and policies 204 may be provided with a common interface 206. In this case, any sources 202 and policies 204 may be configured to synchronize data in the class. A class may be any grouping of sources 202 and policies 204. An example of a class may be devices 102 that are found in a home network.

An example of device 102 is shown in FIG. 2. As shown, a policy 204 has been selected from policies 204. Also, sources 202-1 and 202-2 have been selected to manage data in storage 104. An application 212 may be configured to determine which sources 202 and policies 204 should be initiated. For example, application 212 may cause loading of different sources 202 and policies 204. In one example, policies and sources may be loaded at run time allowing devices 102 to be configured on the fly. Thus, different sources 202 and policies 204 may be stored and an application may instantiate the desires sources 202 and policies 204.

A manager 208 manages the communication between sources 202 and/or policies 204. In one embodiment, manager 208 acts as a router and passes events from sources to the policies. Also, information for the events may be sent to user interface 210. Also, manager 208 may pass instructions for actions from policy 204-1 to sources 202. In one embodiment, the manager does not have any knowledge of either the files or metadata that sources 202 control or the rules the policies contain. Rather, manager 208 understands how to pass events from sources 202 to policies 204 and actions from policies 204 to sources 202.

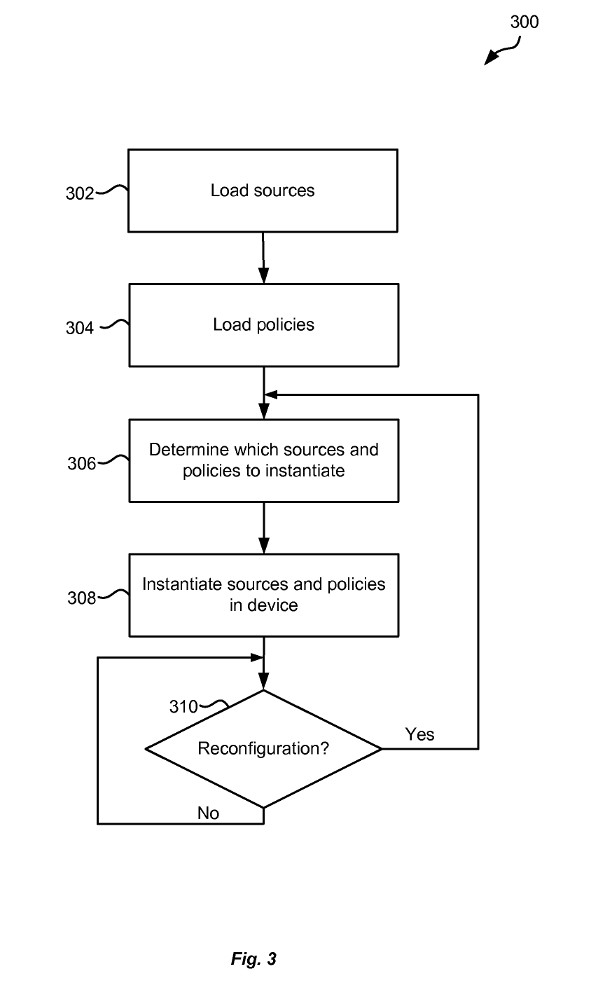

The process of configuring device 102 for data synchronization will now be described. FIG. 3 depicts a simplified flowchart 300 of a method for configuring device 102 according to one embodiment. In one example, application 212 may be used to perform the following steps. Step 302 loads sources 202. For example, a plurality of sources 202 may be loaded onto device 102. This may be performed when a device is manufactured. Also, sources 202 may be downloaded through network 104, such as through the Internet, or sources may be uploaded through other methods.

Step 304 also loads policies 204. Policies 204 may be loaded as described above. In one example, sources 202 and policies 204 may be written by various third parties. Accordingly, different sources and policies 204 may be written and uploaded to devices 102. However, sources 202 and policies 204 include common interface 206, and it is expected that they can communicate without customization or configuration even if they are made by different parties. Thus, policies 204 written by different parties may interact with sources 202 written by different parties as long as interface 206 is used.

Step 306 determines which sources 202 and policies 204 to instantiate. For example, depending on the data synchronization that is desired, different sources 202 and policies 204 may be determined. In one example, application 212 knows which sources 202 and policies 204 are available. Application 212 then determines which sources 202 and policies 204 should be used. For example, a user may configure application 212 to instantiate certain sources 202 and policies 204 to achieve desired data synchronization.

Step 308 instantiates sources 202 and policies 204 in device 102. For example, application 212 may instantiate sources 202 and policies 204 dynamically.

Step 310 determines if reconfiguration is necessary. For example, different policies 204 and sources 202 may be reconfigured in device 102 depending on the data synchronization that is desired. If reconfiguration is necessary, then the different sources and policies may be instantiated.

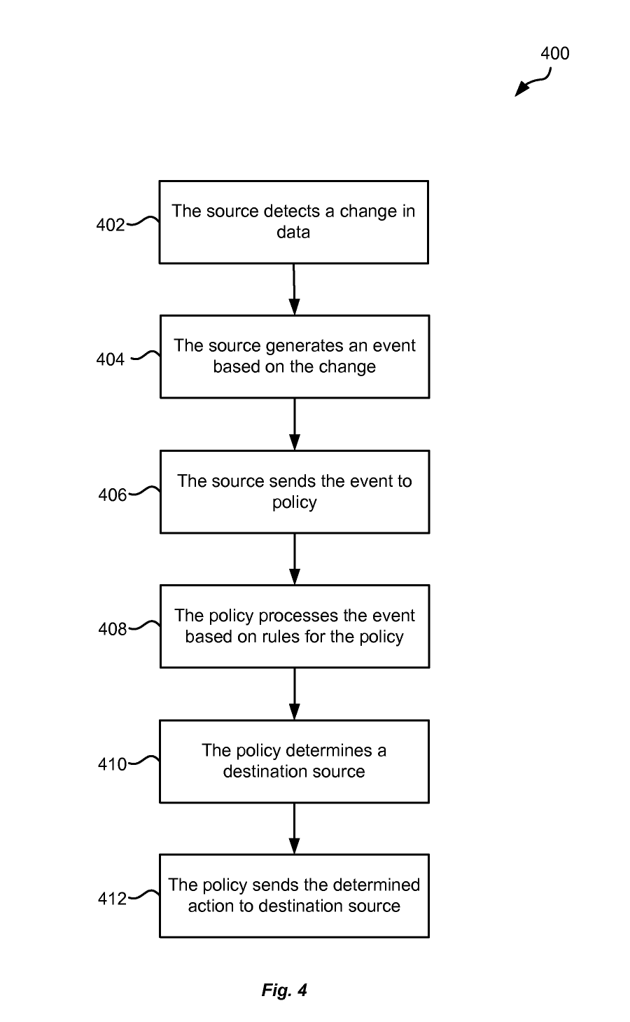

Once policies 204 and sources 202 are instantiated, data synchronization may be performed. FIG. 4 depicts a simplified flowchart 400 of a method for performing data synchronization according to one embodiment. In step 402, source 202-1 detects a change in data. For example, a change in a file or metadata that source 202-1 is monitoring may be detected. In step 404, source 202-1 generates an event based on the change. The event may describe the change that occurred. Also, the event may include information for the change, such as the data that is changed.

In step 406, source 202-1 sends the event to policy 204. The event may be sent using common interface 206. Manager 208 receives the event and can forward it to policy 204. Because common interface 206 is used, configuration between source 202-1 and policy 204 is not needed. Rather, source 202-1 is configured to send an event using common interface 206. Policy 204 is configured to read events from common interface 206 and can process the event based on its policy.

In step 408, policy 204 processes the event based on rules for the policy. For example, the event is applied to the rules and an action is determined.

In step 410, policy 204 determines a destination source 202-2. For example, the destination source may be a different source than 202-1.

In step 412, policy 204 sends the determined action to destination source 202-2. Destination source 202-2 may then perform the action. In one example, data synchronization is performed based on the action, such as data that was changed for source 202-1 is changed for data being monitored by source 202-2.

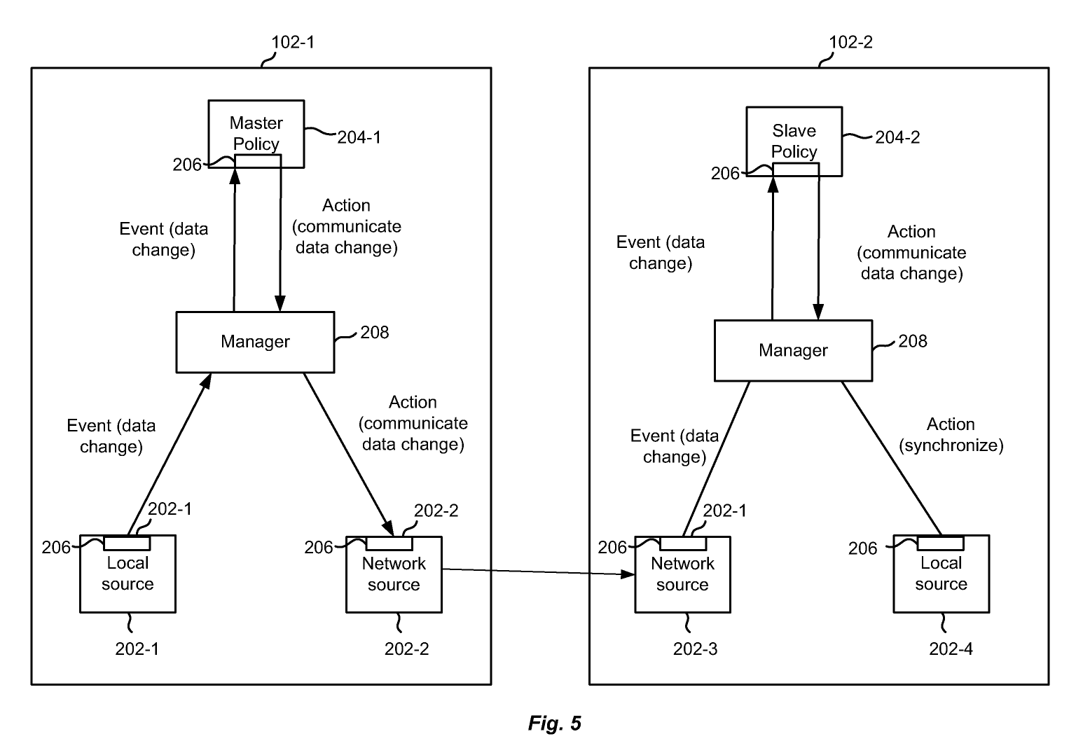

FIG. 5 depicts a more detailed example of devices 102 that can be used for data synchronization according to one embodiment. Although this example is described, it will be understood that other examples may be appreciated. A device 102-1 and device 102-2 are provided. Each device includes policies 204 and sources 202.

A source 202-1 may be a local source and a source 202-2 may be a network source. The local source may be configured to manage data that is local to device 102-1. Network source 202-2 may be configured to communicate with other devices 102, such as device 102-2. Similarly, device 102-2 includes a network source 202-3 and a local source 202-4.

A policy 204-1 may apply a first set of rules for a first policy for device 102-1 and a policy 204-2 may apply a second set of rules for a second policy for device 102-2. In one example, policy 204-1 may be a master policy and policy 204-2 may be a slave policy. In this case, a master/slave data synchronization may occur. The policy may synchronize data between devices 102-1 and 102-2, such as when data changes occur on device 102-1, they are synced with data that is stored on device 102-2.

In operation, local source 202-1 may control data that is stored. When changes in data are detected, local source 202-1 generates an event, which is sent through manager 208 to policy 204-1. Rules in master policy 204-1 indicate that it should copy changes in data being monitored from the master to the slave. Accordingly, an action is generated to have the information for the data that is changed sent to device 102-2 for synchronization. In this case, an action may be sent to network source 202-2, which is configured to send the data to device 102-2.

Network source 202-2 sends a message over network 104 including the changed data to network source 202-3. Network source 202-3 receives the changed data and is configured to send an event to policy 204-2 indicating that it has received data that has changed. Rules in slave policy 204-2 indicate that changes in data to the master device should be replicated in the slave device. Accordingly, an action is generated and sent to local source 202-4 that indicates that it should duplicate the changes in data in its files. Local source 202-4 then takes the changed data and stores in the files.

The process may also work in reverse when slave local source 202-4 notices that a file in its area of control has changed. An event may be passed to manager 208 which passes it to policy 204-2. Slave policy 204-2 is then configured to determine through rules that data at the slave should be the same as at the master. An action may then be generated through local source 202-4 to delete the data that has been changed or to change it back to match the master.

In the above example, to perform the master/slave data synchronization, a master policy 204-1 and slave policy 204-2 may be instantiated in devices 102-1 and 102-2, respectively. Master policy 204-1 and slave policy 204-2 may not be configured specifically for devices 102-1 and 102-2. Rather, the policy is a generic master/slave policy.

Local source 202-1 and local source 202-4 may be configured to monitor data. Events are generated when the data is changed. Local sources 202-1 and 202-4 do not know that the policy being enforced for data synchronization is a master/slave policy. Rather, events are generated when data changes and sent to master policy 204-1 or slave policy 204-2. Local sources 202-1 and 202-4 do not know why or how the events are being applied to rules. Thus, a modular data synchronization method is provided. Interfaces 206 are used to communicate events and actions between local sources 202 and policies 204. However, the actions performed by policy 204 or sources 202 are not known to each other. Thus, a plug-and-play architecture is provided in which sources 202 and policies 204 may be instantiated and configured to work together through common interface 106.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. An apparatus configured to synchronize data, the apparatus comprising:
a first source configured to manage data;
a policy configured including one or more rules to manage data synchronization between the first source and a second source; and
an interface between the policy and the original source, the interface allowing multiple polices and multiple sources to be used together to synchronize data, wherein the policy is agnostic of the data being managed by the first source and the first source is agnostic of the one or more rules of the policy.

2. The apparatus of claim 1, wherein the first source is configured to generate an event based on a change in the data being managed, the first source configured to send the event to the policy through the interface.

3. The apparatus of claim 2, wherein the policy is configured to receive the event and to apply the one or more rules to the event to determine an action to perform.

4. The apparatus of claim 3, wherein the policy is configured to send the action to the second source to have data synchronization performed.

5. The apparatus of claim 1, wherein the interface includes a first interface for the first source and a second interface for the policy.

6. The apparatus of claim 1, further comprising a manager configured to route communications from the first source to the policy, the manager agnostic of the data being managed by the first source and the one or more rules of the policy.

7. The apparatus of claim 1, further comprising an application configured to instantiate the first source and the policy.

8. The apparatus of claim 7, wherein the application is configured to instantiate the first source from a plurality of sources and the policy from a plurality of policies dynamically to achieve a desired data synchronization.

9. A method for synchronizing data, the method comprising:
monitoring, at a first source, data;
determining, at the first source, an event based on the data being monitored;
sending the event to a policy;
determining, at the policy, an action for the event based on one or more rules;
sending the action to a second source, the action causing data synchronization between the first source and the second source, wherein the policy is agnostic of the data being monitored by the first source and the first source is agnostic of the one or more rules of the policy.

10. The method of claim 9, wherein the interface includes a first interface for the first source and a second interface for the policy.

11. The method of claim 9, further comprising routing the event from the first source to the policy through a manager and the action through the manager to the second source, the manager being agnostic of the data being managed by the first source and the one or more rules of the policy.

12. The method of claim 9, further comprising instantiating the first source from a plurality of sources and the policy from a plurality of policies dynamically to achieve a desired data synchronization.

13. The method of claim 9, wherein combinations of the plurality of sources and plurality of policies can be instantiated together without sources knowing the rules of the policies and the policies not knowing the data being managed.

14. An apparatus comprising:
one or more processors; and
logic encoded in one or more tangible media for execution by the one or more processors and when executed operable to:
monitor, at a first source, data;
determine, at the first source, an event based on the data being monitored;
send the event to a policy;
determine, at the policy, an action for the event based on one or more rules;
send the action to a second source, the action causing data synchronization between the first source and the second source, wherein the policy is agnostic of the data being monitored by the first source and the first source is agnostic of the one or more rules of the policy.

15. The apparatus of claim 14, wherein the interface includes a first interface for the first source and a second interface for the policy.

16. The apparatus of claim 14, wherein the logic when executed is further operable to route the event from the first source to the policy through a manager and the action through the manager to the second source, the manager being agnostic of the data being managed by the first source and the one or more rules of the policy.

17. The apparatus of claim 14, wherein the logic when executed is further operable to instantiate the first source from a plurality of sources and the policy from a plurality of policies dynamically to achieve a desired data synchronization.

18. The apparatus of claim 14, wherein combinations of the plurality of sources and plurality of policies can be instantiated together without sources knowing the rules of the policies and the policies not knowing the data being managed.
